(19) United States
(12) Patent Application Publication
(10) Pub. No.: US 2017/0197548 A1
(43) Pub. Date: Jul. 13, 2017

(54) METHODS AND DEVICES FOR PREVENTING INJURY TO A VEHICLE PASSENGER OR PACKAGE

(71) Applicants: JANEEN J. THOMAS, FAYETTEVILLE, GA (US); JUBIN S. THOMAS, FAYETTEVILLE, GA (US)

(72) Inventors: JANEEN J. THOMAS, FAYETTEVILLE, GA (US); JUBIN S. THOMAS, FAYETTEVILLE, GA (US)

(21) Appl. No.: 15/403,669

(22) Filed: Jan. 11, 2017

Related U.S. Application Data
(60) Provisional application No. 62/277,681, filed on Jan. 12, 2016.

(51) Int. Cl. B60Q 9/00; B60R 16/03; G08B 25/10; B60N 2/00

(52) U.S. Cl. CPC B60Q 9/00; B60N 2/002; B60R 16/03; G08B 25/10

(57) ABSTRACT

The present disclosure comprises methods and devices for alerting those outside a vehicle that a passenger or package is present within the vehicle.

### CROSS-REFERENCE TO RELATED APPLICATIONS

This application claims the priority of and benefit of the filing date of U.S. Provisional Patent Application No. 62/277,681, filed Jan. 12, 2016, which is incorporated herein by reference in its entirety.

### TECHNICAL FIELD

The present disclosure comprises methods and devices for preventing injury or death to a passenger restrained within a vehicle or for preventing damage to articles left in a vehicle, such as a car, truck, van, bus, or aircraft.

### BACKGROUND

According to the Department of Meteorology and Climate Study at San Jose State University, seventy-four heat stroke deaths among children in the United States during 2013-2014 were caused by exposure to high heat conditions while being restrained within a vehicle for an extensive period of time. Fifty-three percent of incidents among children, aging from five days to fourteen years old, occurred when the child was unintentionally left in a heated vehicle by the caregiver. Data shows that hyperthermia can occur, even at mild outside temperatures, when the internal body temperature reaches life-threatening levels.

Legislative attempts have been made to prevent deaths from excess heat while restrained in a vehicle. Twenty states have enacted laws, and another fourteen states have proposed legislation against leaving a person, such as a child, unattended in a vehicle. Devices that would accurately predict the presence of a child are not available on the market due to limitations such as inconsistency in arming sensitivity, potential interference from mobile phones and other electronic systems, short-circuits that can be caused by liquid spills, and disarming the device when the passenger shifts position.

What is needed are cost-effective devices that could prevent overheating injury, damage or death to a restrained person or package in a vehicle and methods for using such devices.

### SUMMARY

The present disclosure comprises methods and devices for alerting or reporting of the presence of a person, animal or article in a vehicle. Methods of the present disclosure comprise methods for making and using devices that alert or report the presence of a person, animal or article in a vehicle. Devices of the present disclosure comprise at least a power source, a passenger or package detector, an occupant abandonment detector, and a signaling module.

### DESCRIPTION OF FIGURES

FIG. 1 shows data regarding the consistency and operation of an exemplary device with varying masses used to trigger the device.

FIG. 2 shows data regarding the consistency and operation of an exemplary device with varying distances between the RF receiver and the vehicle key fob.

FIG. 3 shows an exemplary circuit board for an exemplary device of the present disclosure.

FIG. 4 shows a flowchart of a method of use of an exemplary device of the present disclosure.

FIG. 5 shows an exterior view of an exemplary device of the present disclosure.

FIG. 6 shows an interior view of an exemplary device of the present disclosure.

FIG. 7 shows the back outside of a child's car seat with an article detector switch activated by pressure from the restraint straps.

FIG. 8 shows an exemplary article detector, which is a switch.

### DETAILED DESCRIPTION

The present disclosure comprises methods and devices for alerting or reporting the presence of a person, animal, other living organisms, or article in vehicle or other location. Such methods and devices are useful in, for example, preventing injury or death from heat exposure to a passenger restrained within a vehicle. As an example herein, the passenger is described as a child, and the restraint system is a child car seat with its seatbelts (restraints), in a car in which the interior of the car can reach temperatures that are injurious or deadly to a child. This disclosure is not to be considered limiting, as the passenger may be a living entity such as a human of any age or physical ability, and may include animals, such as pets or livestock that are restrained within a vehicle. The vehicle can be any vehicle that can contain living organisms, such as humans or other animals. In an aspect, the restrained entity can be any living or non-living material that could be harmed by remaining within the vehicle, such as by exposure to high temperatures or low temperatures in a vehicle, and may include, but is not limited to, plants, microbial cultures, flowers, plant parts, body organs or tissues, food, medications, merchandise, frozen products, heat-sensitive objects, packages, bags, purses, wallets, cellular devices and other electronic devices. As used herein, such living and non-living entities may be referred to as an article for ease of communication. In some aspects, the vehicle may comprise a location where an article is stationary, including but not limited to a location indoors or outdoors, and not a mode of transportation.

A large proportion of heated vehicle deaths occur due to adult misjudgment and lack of forethought. It is accepted that there is no period of time that is safe for permitting a child to remain in a car. Hyperthermia occurs in the human when the body temperature exceeds one-hundred-and-four degrees, and the temperature within a car parked in a location with an external temperature of seventy-two degrees may increase thirty to forty degrees in one hour. Overheating of the article is one aspect of damage that can occur to an article, and such damage may also include, but is not limited to, exposure to cold, lack of water, food or air exchange, and the like.

Psychologically, these incidents of forgetting the presence of a body or package in a car can occur to any driver, such as a parent or caregiver. A driver's memory is challenged when the brain needs to remember an activity that is not routine, such as taking a child to school. If a child has fallen asleep in his or her car seat, which is usually behind the driver's seat, there is no visual information to remind the that there is a child to drop off and if not a routine activity, the driver needs a cue.

According to the World Health Organization, an average child weighs a minimum of six-and-a-half pounds at birth (Growth), and further research proves that ethnicity, socio-economic status and type of feeding does not affect this data (Acta). When used for detecting small children, an exemplary device is activated by a system with a threshold weight detection at or below six-and-a-half pounds. The average decibel range for a human with perfect hearing is from negative twenty decibels to one-hundred-forty decibels (Smith). For an audible alert system, an exemplary device may trigger or emit an audible sound between sixty and one hundred decibels. This will ensure the owner of the vehicle and bystanders can hear the device, but no hearing damage is endured by anyone within the audible zone. Most car alarm systems utilize RF technology which transmits over 315 MHz (Hamblen). If the device created for this purpose has the capability to receive the same signal, the device would be classified as portable and chances of electronic interference would be reduced. If a RF receiver is embedded in the device, the cost of producing such a device would be lower compared to others on the market.

Disclosed herein is an exemplary device used for alerting or reporting the presence of a person or package in a vehicle, such as a child in a car, restrained in a car seat. An exemplary device alerts or reports to a driver exiting a car that the child or package remains within the car. It is helpful if a device has the following characteristics: Cost effectiveness—Affordable for the target market, parents of young children and toddlers. Portability—Capable of being removed and re-installed. Consistency and Orientation—Operate under any orientation in which the child is positioned. Electronic Interference—Avoid interference between the device and other devices. Short-circuits and disarming—Prevention of interference with a device or damage to a device. The casing of a device can be waterproof material, and the disarming of the device is childproof, so a child cannot disarm a device.

The following table, Table I, provided for convenience only and lists the various reference numbers and their description as used herein and as shown in figures.

TABLE I

| Ref. No. | Description |
|---|---|
| 1 | Exemplary circuit diagram a disclosed exemplary device |
| 10 | Power source |
| 11 | On-Off switch |
| 12 | Article detector |
| 13 | Exiting detector |
| 14 | Signaling module (audible) |
| 15 | Signaling module (visual) |
| 20 | Exiting transmitter |
| 31 | Lower casing (body of casing) |
| 32 | Upper casing (lid of casing) |

In an aspect, a device of the present disclosure is activated by a determined weight, such as the weight of the article to be monitored, such as a package, a child, a wheelchair, an animal cage, etc. An average child weighs a minimum of six-and-a-half pounds at birth and ethnicity, socio-economic status and type of feeding does not affect this data. For example, a device may be activated to detect from 0.01 pounds to 200 pounds or greater, and all ranges in between 0 feet and 120 feet or greater.

In an aspect, a device of the present disclosure emits an audible sound between sixty and one hundred decibels. The average decibel range for a human with perfect hearing is from negative twenty decibels to one-hundred-forty decibels. The alert function of a device ensures that those outside the vehicle can hear the device when it alerts.

Most car alarm systems utilize RF technology which transmits over 315 megahertz (MHz). In an aspect, a device of the present disclosure receives the same signal that the vehicle receives from its key fob, the device is portable and the risk of electronic interference is reduced. In an aspect, the RF receiver is embedded in or otherwise in connectivity with the device.

In operation, a device disclosed herein provides auditory and visual alerts to others that the article, passenger or package, is within the vehicle. In an aspect, a disclosed device is portable and can be removed and re-installed. In an aspect, a disclosed device operates effectively regardless of the orientation of the passenger or package. In an aspect, the device uses a known wireless system or contains no wireless products at all. In an aspect, the casing of the device is made of waterproof material. In an aspect, it is desired that the article, such as a passenger, cannot disarm the device.

A device disclosed herein comprises or consists of components including, a power source or power inlet for connecting to an external power source; an article detector, also referred to as a passenger or package detector, an exiting detector, also referred to as an occupant abandonment detector; and a signaling module. Other components in a disclosed device include a casing to contain components or to which components are attached or embedded, a switch to turn the device on or off; connecting elements for connecting the components, which may include wires, or signals such as RF (radio frequency), wireless communications, or Bluetooth connections, and a control unit. The switch may be in a wall of the casing for ease of turning the device off or on.

A casing may have openings in one or more of its walls through which wires or connecting elements traverse. Some components may be within the casing, some components may be attached to the exterior or interior of the casing, and some components may be distant from the casing, but still connected to the other components.

An exemplary disclosed device comprises a power source, optionally an on-off switch, an article detector, an exiting detector, and one or more signaling modules. The disclosed device can further comprise an exiting transmitter, e.g., an RF transmitter such as car key lock fob transmitting at 315 MHz.

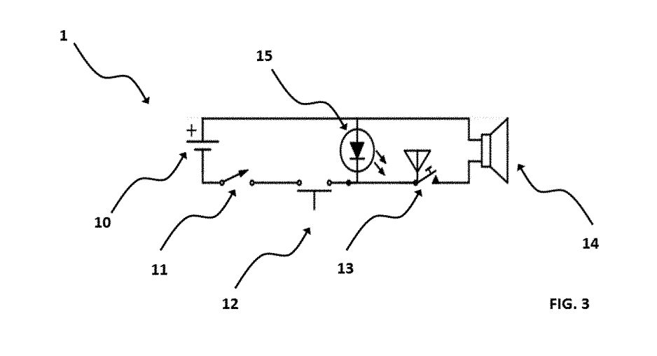

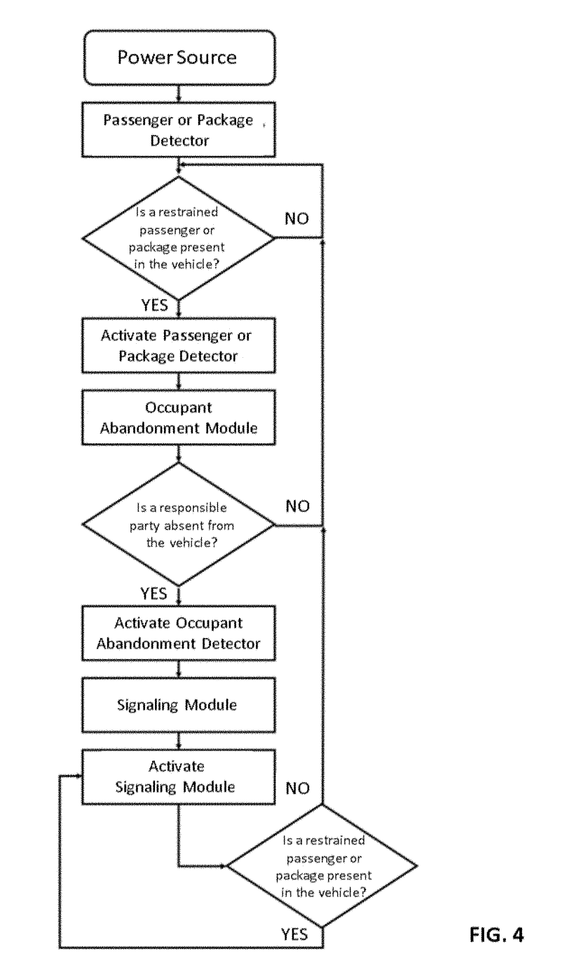

Referring now to FIG. 3, the figure shows a schematic circuit diagram for an exemplary disclosed device, 1. Briefly, the circuit comprises a power source, 10, and an on-off switch, 11, to power the circuit on or off when in use or not, which are in electrical communication, as shown, with an article detector, 12, an exiting detector, 13, an audible signaling module, 14, and a visual signaling module, 15.

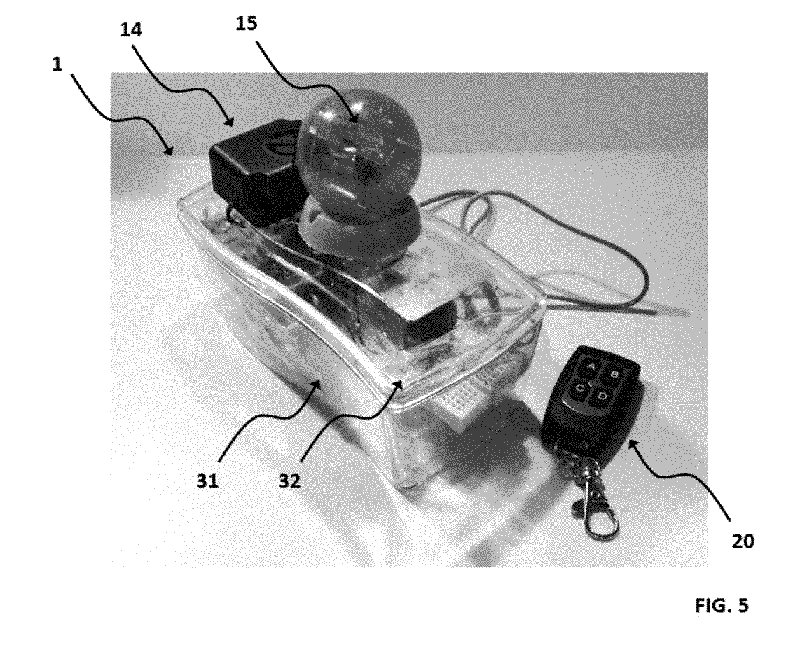

Referring now to FIG. 5, the figure shows a photographic image of an exemplary disclosed device, 1l next to an exemplary disclosed exiting transmitter, 20. In the figure, the exiting transmitter is an RF key fob. The figure shows an external view of a device, 1, comprising an audible signaling module, 14, and a visual signaling module, 15, with a upper and lower case housing, 31 and 32, respectively.

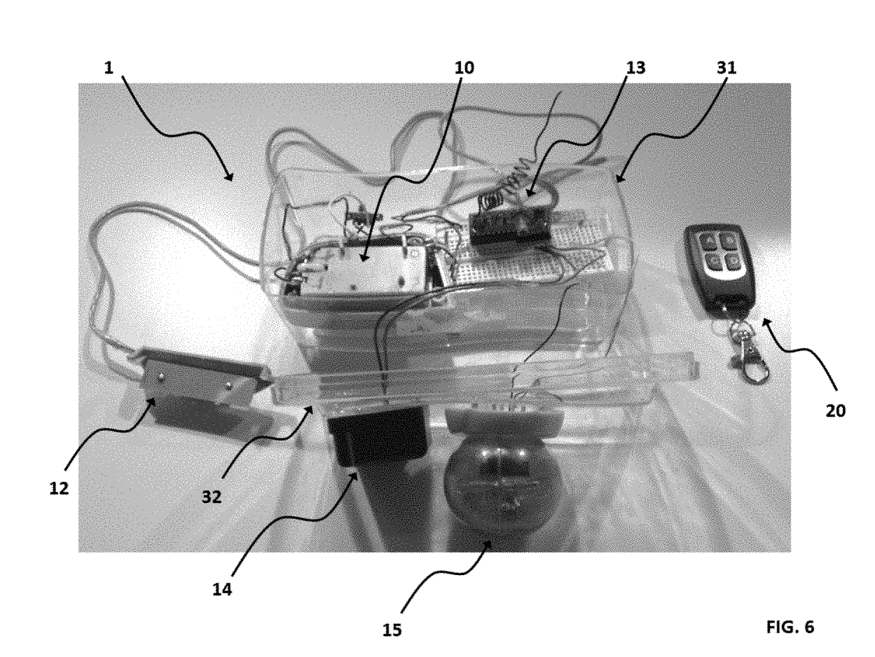

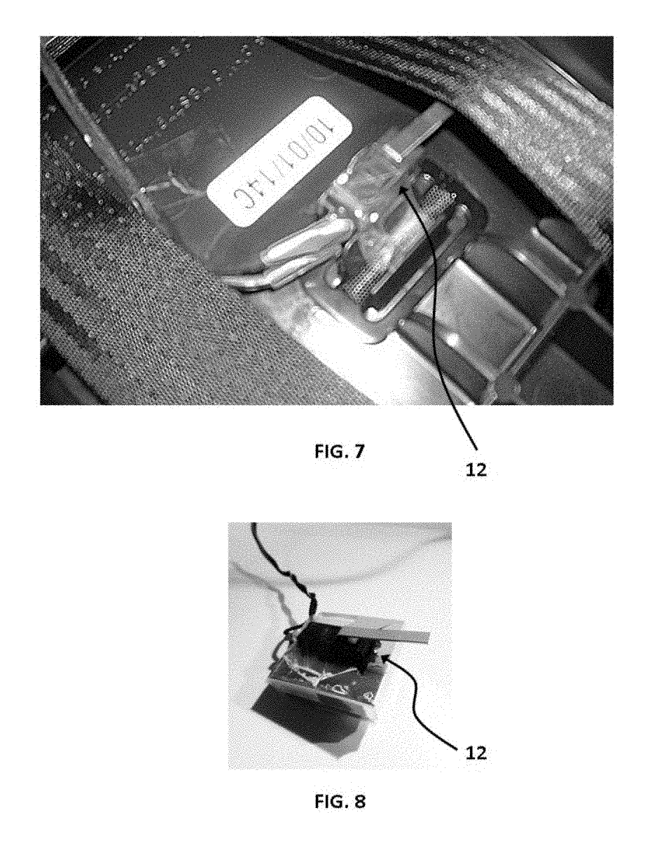

Referring now to FIG. 6, which shows an internal view of components within a disclosed reporting device, 1, shown in FIG. 5. As shown in FIG. 6, device 1 comprises a power source, 10, and an exiting detector, 13, and a wiring connection between the components contained within or on the upper and lower case housing, 31 and 32, respectively, to an article detector, 12. Further views of exemplary article detector, 12, comprising a rocker switch are shown in FIGS. 7 and 8. FIG. 8 shows an exemplary article detector, 12, comprising a rocker switch, in communication with a child safety seat. In alternative aspects, the article detector, 12, can be in communication within or beneath a passenger seat, in order to provide detection of a restrained or other passenger. In a further alternative aspect, the article detector, 12, can be in communication beneath a floor or trunk mat in order to detect an article or object placed thereon on. Although, FIGS. 6-8 show a wired connection between the article detector, 12, and the other components of the disclosed device, 1, but the connection in the disclosed device is not limited to a wired connection and in alternative aspects, the connection between the article detector, 12, and the other components of the disclosed device, 1, can be a wireless connection.

As described above, disclosed device 1 comprises a power source, e.g., see 10 in FIG. 3, which may be a source of electricity, including, but not limited to, battery power, rechargeable battery power, vehicle power outlet (power from the vehicle) and solar power. A power inlet is an element that accepts electricity provided from a source, such as a receiver for receiving a power plug or the like, for example from the cigarette lighter/power source of a car. A power source can include, but not limited to: electrical power from an independent battery; electrical power from an independent battery that can be recharged utilizing a source or sources of electricity such as, but not limited to, household electricity, a vehicle battery, solar power, and/or an electrical generator; electrical power from a vehicle power outlet which draws electricity from a vehicle battery; and electrical power that is converted from solar energy.

As described above, disclosed device 1 comprises an article detector or passenger or package detector such as 12 in FIG. 3, which is a component that detects the presence of an article, for example, a restrained or stationary passenger or package, within a vehicle, including, but not limited to, one or more of a switch such as push-button switch, rotary switch, toggle switch, rocker switch, roller switch, slide switch or proximity switch, or one or more sensors such a seatbelt tensioner sensor, a pressure sensor, a motion sensor, a thermal sensor, a chemical sensor or a magnetic or electromagnetic sensor. A disclosed article detector includes, but is not limited to, a push-button switch in which the analog component is activated by the pressure of a restrained or stationary passenger or a package placed in a particular location such as, but not limited to, a vehicle, a car seat, and/or a vehicle mat; or rotary switch in which the analog component is activated by the motion in any direction of a restrained or stationary passenger or a package placed in a particular location such as, but not limited to, a vehicle, a car seat, and/or a vehicle mat; a toggle switch in which the analog component is activated by the motion of a projecting lever in one direction caused by the motion of a restrained or stationary passenger or a package placed in a particular location such as, but not limited to, a vehicle, a car seat, and/or a vehicle mat; a slide switch in which the analog component is activated by the motion of a slider in one direction caused by the motion of a restrained or stationary passenger or a package placed in a particular location such as, but not limited to, a vehicle, a car seat, and/or a vehicle mat; a proximity switch in which the analog component is activated by a metallic part on a restrained or stationary passenger or package approaching the magnetic or electromagnetic field of the analog component placed in a particular location such as, but not limited to, a vehicle, a car seat, and/or a vehicle mat; sensor activated by the pressure of a seatbelt tensioner on a car or a car seat. Sensors may function in a manner similar to a switch in being able to discriminate the continued presence of an article or the movement of an article from its initial position. For example, an article detector may comprise a sensor activated by the pressure of a restrained or stationary passenger or a package placed in a particular location such as, but not limited to, a vehicle, a car seat, and/or a vehicle mat; a sensor activated by the motion of a restrained or stationary passenger or a package placed in a particular location in a vehicle; a sensor activated by the thermal energy radiated by a restrained or stationary passenger or a package placed in a particular location in a vehicle; a sensor activated by the chemical changes in a vehicle with the presence of a restrained passenger or a package; and sensor activated by the magnetic or electromagnetic forces between a restrained passenger or a package, and locations such as, but not limited to, a vehicle, a car seat, and/or a vehicle mat. As used herein, a vehicle can be any device used for transportation. Alternatively, an article may be placed at any location, not limited to a vehicle, but may be placed in a building, a container or at any particular location where it is desired for the article to remain for a desire amount of time, and from which monitoring of movement or lack of movement from such a location is desired.

As described above, a disclosed device comprises an exiting detector, or alternatively referred to as an occupant abandonment detector, is defined as a component that detects the exiting of the driver or other persons (other than the restrained or stationary article) from the vehicle, such that the article is left unattended in the vehicle, including, but not limited to, a RF receiver, switches such as push-button switch, rotary switch, toggle switch, slide switch, proximity switch and vehicle operational detection switch, and sensors such seatbelt tensioner sensor, pressure sensor, motion sensor, thermal sensor and magnetic or electromagnetic sensor.

An exiting detector comprises, but is not limited to, a receiver, such as an RF receiver, for receiving or detecting a signal from an exiting transmitter, e.g., an RF transmitter such as vehicle key fob transmitting at 315 MHz, that can be used to provide a signal that a responsible party (a party other than the article or restrained passenger) has removed itself from the initial location in proximity to the article or restrained passenger, for example, exited the vehicle. For example, a responsible party using the key fob to lock the car doors, will simultaneously transmit an RF signal that is received by the exiting detector, thereby signaling to the disclosed device that the responsible party has left the vehicle.

In an aspect, an exiting detector can comprise a push-button switch in which the analog component is activated by the absence of pressure of a responsible party which was initially located in a particular location and activated the switch; a rotary switch in which the analog component is activated by the motion in any direction of a responsible party which was initially located in a particular location and activated the switch; a toggle switch in which the analog component is activated by the motion of a projecting lever in one direction caused by the motion of a responsible party which was initially located in a particular location and activated the switch; a slide switch in which the analog component is activated by the motion of a slider in one direction caused by the motion of a responsible party which was initially located in a particular location and activated the switch; a proximity switch in which the analog component is activated by a metallic part on a responsible party departing the magnetic or electromagnetic field of the analog component which was initially located in a particular location and activated the switch; or a vehicle operational change detection switch in which the analog component is activated by the change of the vehicle from an operational state to parked.

In an aspect, an exiting detector may comprise a sensor activated by the absence of pressure of a seatbelt tensioner on a car or a car seat; a sensor activated by the absence pressure of a responsible party which was initially located in a particular location and activated the sensor; a sensor activated by the motion of a responsible party exiting a vehicle; a sensor activated by the absence of thermal energy radiated by a responsible party which was initially located in a particular location; and sensor activated by the absence of magnetic or electromagnetic forces between a responsible party which was initially located in a particular location.

In an aspect, a disclosed device comprises a signaling module, which is a component that alerts or notifies others (including, but not limited to, a responsible party) of the presence of a restrained or stationary passenger or package within a vehicle, including, but not limited to, an audible alarm, visual alert and verbal or written communication through an electronic device, such as phone calls, short message service (SMS), Bluetooth communication, Wi-Fi-enabled communication, satellite-based communication, near-field communication (NFC). A signaling module may include one or more elements that alert or notify others, such as an audible alarm, a visual alert and a written or readable communication. In an aspect, a signaling module includes, but is not limited to: an element that emits an audible noise, for example alerting the responsible party and/or bystanders of the presence of a restrained or stationary passenger or package in a vehicle; an element that emits a visual indication, for example for alerting the responsible party and/or bystanders of the presence of a restrained or stationary passenger or package in a vehicle; an element that initiates a text or telephone call to receiving (electronic) devices alerting the responsible party and/or bystanders of the presence of a restrained or stationary passenger or package in a vehicle; an element for transmitting short message service (SMS) messages to electronic devices alerting the responsible party and/or bystanders of the presence of a restrained or stationary passenger or package in a vehicle; an element for Bluetooth communication to electronic receiving devices alerting the responsible party and/or bystanders of the presence of a restrained passenger or package in a vehicle; an element for Wi-Fi-enabled communication to electronic devices alerting the responsible party and/or bystanders of the presence of a restrained passenger or package in a vehicle; an element for satellite-based communication to electronic devices alerting the responsible party and/or bystanders of the presence of a restrained passenger or package in a vehicle; or an element for Near-field communication (NFC) to electronic devices alerting the responsible party and/or bystanders of the presence of a restrained passenger or package in a vehicle. One or more of these elements may be used in a disclosed device. Elements are known in the art, for example, see U.S. Pat. No. 6,956,467, which is incorporated herein in its entirety.

In an aspect, components of a reporting device disclosed herein comprise a power source, a passenger or package detector, an exiting detector, and a signaling module that can be connected serially. In an aspect, one or more of the components may be embedded in locations including, but not limited to, a vehicle, a seat, and/or a mat in a vehicle or other location. Connections between components may be wired or wireless, as is known in the art.

A disclosed device may further include a control unit component comprising general or special purpose processors, application specific processors, firmware and discrete components or combinations thereof. A control unit may be activated and provide the alarm or may be activated in addition to an alarm. A control unit may function to call specific telephone numbers, send text messages, or otherwise provide information to electronic devices.

A method for using a reporting device of the present disclosure comprises, a) providing a reporting device within a vehicle, wherein the reporting device comprises an article detector, an exiting detector, a signaling module and either a power source or power inlet, and in no particular order, b) activating the article detector by placing an article so that the article detector is activated; and c) providing power to the reporting device. The method further comprises d) activating the exiting detector, which communicates with the signaling module, activating the signaling module so that an alarm or notification is provided, for example, to a responsible party.

For example, a reporting device disclosed herein comprising one or more article detectors is provided to a child's car seat. One or more article detectors are attached to one or more of the restraint straps of a child's car seat. To prevent a child from disabling the device accidently, the detector(s) may be placed so that the article detectors are in contact with the portion of the child restraint straps that are located on the back outside of the child's car seat, the surface of the car seat that faces the seating area of the vehicle seat. An article detector(s) is activated by the restraint straps being moved to be tight against the back of the child's car seat when the restraint straps are fastened around a child in the child's car seat. An article detector, for example, a mechanical switch, such as the one shown in FIG. 8, is activated by the tightening of the restraint straps against the back of the car seat. See FIG. 7, for example. The power source, for example, batteries, is providing power to the device. A child is present in the car seat with its restraining straps holding it in, and the article detector(s) is activated. A driver enters the vehicle and the vehicle may move. (There is no need for the vehicle to move from the location where the article entered the vehicle, what is needed is for the exiting detector to be activated.) The driver then exits the vehicle and activates the locking system of the car, for example using a signal from a key fob. The signal from the key fob also activates the exiting detector of the device, which communicates with and activates the signaling module. For example, activating the signaling module causes a light to turn on and/or an auditory alarm sounds.

For example, a portable reporting device as disclosed herein is provided to a vehicle so that when a box of flowers is placed on a car mat for the rear seat of a car, the article detector of the device is activated. For example, the article detector may be a mechanical switch that is activated, “turned on”, by the weight of the article, the box of flowers. The article detector is connected to the power source. The power source is also connected to the exiting detector and the signaling module. The exiting detector is activated by the RF signal from the key fob of the vehicle. The RF signal is sent when a person activates the locking system of the car. Once the exiting detector is activated, it communicates with the signaling module so that the signaling module provides an alarm. For example, the alarm is an auditory alarm that is heard by persons outside the vehicle. An alarm can also be sent as a text message to a predetermined telephone number, such as that of a responsible party, e.g., the driver.

An aspect of the present disclosure comprises methods for alerting others to the presence of a restrained passenger or package in a vehicle. For example, a portable reporting device as disclosed herein is provided to a vehicle so that when a wheelchair with a person thereon is placed on a mat in a transport vehicle, the article detector of the device is activated. For example, the article detector may be a mechanical switch that is activated, “turned on”, by the weight of the article, the wheelchair. The article detector is connected to a reporting device and its power source. The power source of the device is also connected to the exiting detector and the signaling module. The exiting detector is activated by the RF signal from the key fob of the vehicle. The RF signal is sent when a person activates the locking system of the car. Once the exiting detector is activated, it communicates with the signaling module so that the signaling module provides an alarm. For example, the alarm is an auditory alarm that is heard by persons outside the vehicle. An alarm can also be sent as a text message to a predetermined telephone number, such as that of a responsible party, e.g., the driver.

The present disclosure comprises methods for alerting other individuals to the presence of a restrained passenger or package in a vehicle. Once others are alerted, the restrained passenger or package can be removed from the vehicle, if needed.

The present disclosure comprises methods for preventing injury or death from exposure to excess heat in a vehicle by alerting other individuals that a restrained passenger or package is within the vehicle so that the passenger or package can be removed from the vehicle and thus preventing damage, injury or death from heat exposure.

### REFERENCES

[1] Mann, Denise WebMD. “Dangers of Leaving Kids in Hot Cars and How to Prevent It.” WebMD. WebMD, n.d. Web. 27 Sep. 2014.
[2] Null, CCM, Jan. “Fact Sheet—Heatstroke Deaths of Children in Vehicles.” Fact Sheet—Heatstroke Deaths of Children in Vehicles. Department of Meteorology & Climate Science-San Jose State University, 23 Sep. 2014. Web. 27 Sep. 2014.
[3] OSHA. “Electrical Safety.” Electrical Safety. US Department of Labor, n.d. Web. 27 Sep. 2014.
[4] Plungis, Jeff. “U.S.: Sensors to Detect Kids Left in Hot Cars Aren't Reliable.” Detroit Free Press. Bloomberg News, 31 Jul. 2012. Web. 27 Sep. 2014.
[5] Wallace, Kelly. “A Grieving Mother's Mission to Stop Hot Car Deaths.” CNN. Cable News Network, 1 Jan. 1970. Web. 27 Sep. 2014.
[6] Acta Paediatr Supply. “Result Filters.” National Center for Biotechnology Information. U.S. National Library of Medicine, April 2006. Web. 27 Nov. 2014.
[7] “Growth Timeline: Your Child's Size at Different Ages.” BabyCenter. N.p., n.d. Web. 27 Nov. 2014.
[8] Smith, Steven W., Ph.D. “The Scientist and Engineer's Guide to Digital Signal Processing.” Human Hearing. N.p., n.d. Web. 27 Nov. 2014.
[9] Hamblen, Jim. “IR and RF Remote Controls.” IR and RF Remote Controls. ARMmbed, 7 Jun. 2013. Web. 27 Nov. 2014.

### EXAMPLES

### Example 1

### Making a Device

An exemplary device was assembled according to the steps described herein. First, the following components were placed on a static-free, grounded surface: (a) RF Receiver—315 MHz; (b) keyfob—single button RF remote control—315MHz; (c) modular IC Breadboard Socket; (d) 6VDC Mini Buzzer (commercially obtained); (e) Mini High-Intensity Red LED Light; (f) 4 “D” Battery Holder; (g) 4 “D” Batteries; (h) 16 mm Momentary Detect Switch; and (i) Power Control Switch. Additional materials include a child or infant car seat or booster seat. For testing, a 5 Function Multimeter was used to assess sound intensity and distance parameters. The packaging of the Modular IC Breadboard Socket was removed and wired on the breadboard per the schematic diagram as shown in FIG. 3. For the testing device, the the sticker on the back of the Modular IC Breadboard Socket was removed and the test device stuck to the side of the seat. Next, the switch was placed behind the seat with the pressure switch positioned on the car seat belt. Once assembled as described, the battery pack was disconnected, and the car seat located to a test car, and once in place, the batter pack was reconnected to the circuit. Car doors were closed, and the key fob used to activate the lock switch.

The device was tested by repeating 25 times the placement of switch and car seat, followed by activation with the key fob, with the seatbelt buckled and unbuckled and using different masses. The auditory signal emitted was measured using the multimeter. The data are shown below.

There is minimal or no risk in the described device exhibiting short circuits and electric shock. These risks can be avoided by following all OSHA rules and regulations, e.g., appropriately grounding the device and/or avoiding contact with the device circuit or power supply by conductive jewelry or ornaments including live bands. For example, the main device components and power source can be enclosed in a suitable casing as showing in FIGS. 5 and 6. The casing can be fabricated from a suitable electrical insulating material such as polycarbonate.

### Data Tables:

The graphs and charts below compare the device to industry standards and engineering objectives.

TABLE 1

| Weight (in kilograms) | Activated (Yes/No) | Decibel Emitted |
|---|---|---|
| 3 | Yes | 75 |
| 3 | No | 0 |
| 3 | Yes | 75 |
| 6.5 | Yes | 75 |
| 6.5 | Yes | 75 |
| 6.5 | Yes | 75 |
| 9 | Yes | 75 |
| 9 | Yes | 75 |
| 9 | Yes | 75 |

TABLE 2

| Range (in meters) | Activated (Y/N) | Car Lock (Y/N) |
|---|---|---|
| 3 | Y | Y |
| 3 | Y | Y |
| 3 | Y | Y |
| 7.5 | Y | Y |
| 7.5 | Y | Y |
| 7.5 | Y | Y |
| 9 | Y | Y |
| 9 | Y | Y |
| 9 | Y | Y |
| 13.7 | Y | Y |
| 13.7 | N | Y |
| 13.7 | Y | Y |
| 15.2 | N | Y |
| 15.2 | N | N |
| 15.2 | N | N |

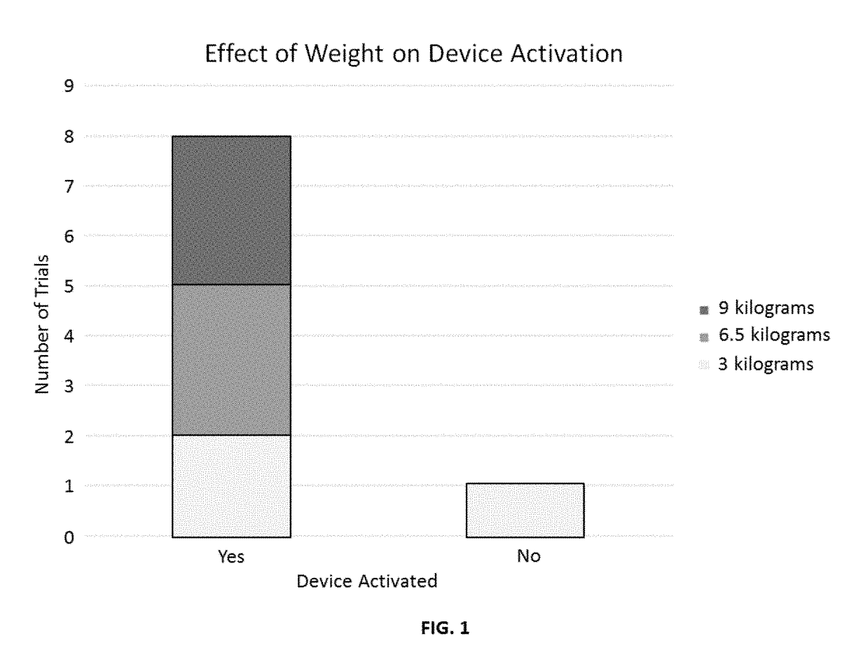

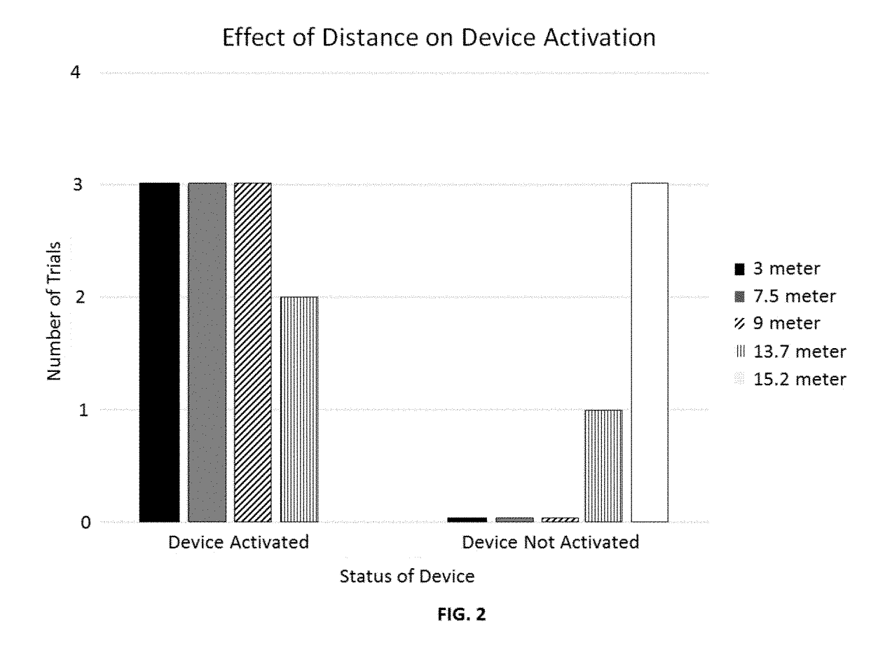

See FIGS. 1 and 2 for the effect of weight on the device and distance on device operation, respectively. In FIG. 1, the success to failure ratio for the device is illustrated. In a sample of nine trials, only one failure occurred. (8:1). FIG. 2 shows that the device can be activated within a nine meter radius of the car. At thirteen and seven tenths meters, the device started experiencing difficulty obtaining the signal. The car and device both failed to operate, as desired, at fifteen and two tenths meters.

A reporting device was tested on the basis of auditory data and its performance. The size of the components used in this device were very small allowing the device to be portable, and a polyurethane casing enclosing the device would prevent short-circuits and stray charges in any situation. In various aspects, the disclosed device can be altered to utilize other technologies. For example, if the RF receiver's antenna was surrounded by a metallic surface, the range of activation would increase.

In an aspect, a polyurethane casing can be designed to fit the device using CAD software and provided in a standard CAD file format (e.g., a .stl file) for printing a casing with a 3D printer.

In an aspect, the device can communicate with a smartphone via Bluetooth or internet connectivity to provide the alert function.

### Example 2

User A places restrained child (mass at or above about three kilograms) in a car seat. A seatbelt tensioner switch is attached to the restraint straps of the car seat. The tension exerted by the child on the seat belt activates the seatbelt tensioner which, in turn, enables the flow of electricity from “D” batteries to an RF receiver. The RF receiver awaits User A's exit from the vehicle which is indicated by a lock RF signal from the vehicle key fob. When User A exits and locks the car while the restrained child is still present in the car (distance between the user and the car from about three to 13.7 meters), User A and bystanders are alerted by a loud buzzing sound and a bright LED light.

### Example 3

User B places wallet (mass at or above about one ounce) in a truck. The first component of a magnetic sensor is placed inside the wallet, and the second component is embedded in the truck. The magnetic forces between the wallet and the truck activate the magnetic sensor which, in turn, enables the flow of electricity from a coin battery to a vehicle operational detection switch. The vehicle operational detection switch awaits User B's exit from the truck which is indicated by a change of the truck from an operational state to parked. When User B exits the truck while the wallet is still present in the truck (distance between the user and the truck up to about 10 meters), User B is alerted by an application-based Bluetooth notification.

### Example 4

User C places package (mass at or above about one ounce) on a car mat. A pressure sensor is embedded in the car mat. The pressure exerted by the package on the car mat activates the pressure sensor which, in turn, enables the flow of electricity, converted from solar energy, to a motion sensor. The motion sensor awaits User C's exit from the van which is indicated by the motion of the user exiting the vehicle. When User C exits the truck while the package is still present in the van (distance between the user and the van up to about 10 meters), User C is alerted by a SMS notification on his electronic device.

1. A reporting device comprising, an article detector; a power inlet or power source, an exiting detector, and a signaling module.

2. The reporting device of claim 1, further comprising a control unit.

3. A method for making a device, comprising, serially connecting an article detector, a power source, an exiting detector and a signaling module.

4. The method of claim 3, further comprising, connecting in serial, a control unit.

5. A method for providing notice of the presence of living or non-living material is present in a vehicle, comprising, a) providing a reporting device within a vehicle, wherein the reporting device comprises an article detector, an exiting detector, a signaling module and either a power source or power inlet, and in no particular order, b) activating the article detector by placing an article so that the article detector is activated; and c) providing power to the reporting device.

6. The method of claim 5, further comprising, d) activating the exiting detector, which communicates with the signaling module, activating the signaling module so that an alarm or notification is provided.
